(19) United States
(12) Patent Application Publication
(10) Pub. No.: US 2019/0114902 A1
(43) Pub. Date: Apr. 18, 2019

(54) HANDHELD EMERGENCY COMMUNICATIONS AND LOCATION IN-FORMATION SYSTEMS

(71) Applicant: Beth Lazarski, Wappingers Falls, NY (US)

(72) Inventor: Beth Lazarski, Wappingers Falls, NY (US)

(21) Appl. No.: 16/209,878

(22) Filed: Dec. 4, 2018

Related U.S. Application Data
(63) Continuation-in-part of application No. 15/650,793, filed on Jul. 14, 2017, now Pat. No. 10,147,304.
Application No. 15/650,793 is a continuation-in-part of application No. 14/820,614, filed on Aug. 7, 2015, now abandoned.
(60) Provisional application No. 62/089,166, filed on Dec. 8, 2014.

(51) Int. Cl. G08B 25/01

(52) U.S. Cl. CPC G08B 25/016

(57) ABSTRACT

A handheld emergency communications and location information system for providing a user with a compact portable handheld product that promotes personnel security. The product provides quick informative access to remote authorities that may help address many different emergencies. The handheld emergency communications and location information system includes a base unit. The base unit includes a self-contained enclosure. The enclosure contains a wireless transmitter and receiver unit, a speaker and alarm unit, a microcontroller, a memory unit, and a power source. User accessible components include one or more emergency signal buttons, a reset/test button, indicator lights, and an object-connector.

### CROSS-REFERENCE TO RELATED APPLICATIONS

The present application is a continuation-in-part of application Ser. No. 15/650,793, filed Jul. 14, 2017, allowed, which is a continuation-in-part of application Ser. No. 14/820,614, filed Aug. 7, 2015, abandoned, which claims priority from provisional application Ser. No. 62/089,166, filed Dec. 8, 2014. All of these references are incorporated herein by reference.

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### FIELD OF THE INVENTION

The present invention relates generally to the field of emergency communication devices and more specifically relates to a handheld emergency communications and location information system.

### DESCRIPTION OF RELATED ART

Personal security is valued by young and old alike. Unfortunately, injuries, burglaries, health issues, and other emergencies occur unexpectedly in a person's life. Everyone desires the feeling of security whether in their homes or outside in unpredictable environments. Unfortunately, unpredictable circumstances occur throughout a person's life, especially when traveling or otherwise away from home. Many individuals living in apartments or condos are not allowed to install home security systems and have no readily available way to call the police for emergency assistance. Others cannot afford to install security systems where they live, and also have no immediate means of contacting appropriate authority when traveling outside their homes. This fear of unexpected harm to one's person often increases as an individual age or becomes involved in relatively dangerous activities.

The risk of personal injury due to health problems and personal injury especially increase when traveling and in more vulnerable situations. Cell phones are often used today to contact emergency personnel by calling 911. Time is extremely valuable when being attacked and attempting to place a phone call may place a victim in more danger. In order to provide themselves with more timely security, many people rely on carrying deadly weapons for self-defense. For many people, who are untrained or not comfortable with weapons, wielding a weapon is not a reasonable option.

Too often, women, seniors, and children are victimized because they are perceived as being defenseless. Generally, they represent a more vulnerable population to predators, thieves, and other scofflaws and as such need viable options to protect themselves. Numerous cases of children kidnappings and abuses occur daily without the victim contacting the appropriate authorities in a timely manner. This is not desirable.

In emergency situations, many people resort to calling 911 for help. When calling 911 to respond to emergencies, callers must wait on the line to reach an operator to describe the emergency. During this process, precious minutes are lost before emergency personnel arrive. Seniors are encouraged to have medical alert systems, making it easy to summon help while they are in their homes, but these systems may not provide coverage when users are away from home. Many seniors and children find the use of mobile phones too complex. Those without home phones or mobile phones, have no reliable way to contact 911 when assistance is needed. Thus, a more convenient, portable, and less complex device is needed to provide personal security to all product owners.

Several attempts have been made to solve the above-mentioned problems such as those found in U.S. Publication. No. 2014/0247124 to Jacqueline V. Ros; U.S. Pat. No. 8,461,983 to Michele McCauley; and U.S. Pat. No. 7,409,044 to Michel Leduc. This art is representative of personal tracking, security, and alarm devices. However, none of the above inventions and patents, taken either singly or in combination, is seen to describe the invention as claimed.

Preferably, a handheld emergency communications and location information system should provide a safe and reliable means for communicating an emergency condition and yet would operate reliably and be manufactured at a modest expense. Thus, a need exists for a reliable handheld emergency communications and location information system to avoid the above-mentioned problems.

### BRIEF SUMMARY OF THE INVENTION

In view of the foregoing disadvantages inherent in the known emergency communication device art, the present invention provides a novel handheld emergency communications and location information system. The general purpose of the present invention, which will be described subsequently in greater detail, is to provide a user-friendly, easily accessible device worn by a user that promotes personal security via information communications with a remote security provider. The present invention may use a cellular telecommunication network or other network to transmit a communication signal to the remote security provider. The present invention may also receive a GPS signal containing information pertinent to the absolute location of the user or relative to the remote security provider. The microcontroller can be configured to transmit this information when activated by the user.

A handheld emergency communications and location information system is disclosed herein in various embodiments; a first embodiment comprising a base unit including a self-contained enclosure containing a wireless transmitter-and-receiver unit (TR unit); a microcontroller; a memory unit; a power source; and an emergency signal button. Some versions of the system comprise a digital display connected to the microcontroller and some comprise a speaker-and-alarm unit connected to the microcontroller and configured to emit a sound when activated by the microcontroller.

The microcontroller controls the TR unit to receive and track an absolute or relative location of the base unit. This allows the system to communicate location data to the remote security provider, such as through the wireless signal.

The present invention begins location communication with a remote monitoring station upon application and emergency signal buttons or when the microcontroller receives input from an emergency signal button that matches a predefined pattern, thus saving battery power and extending use.

The base unit of the current invention comprises a self-contained enclosure. The base unit of the portable handheld emergency communications and location information system may be transported on the body of a user via an object-connector. In some embodiments, the object-connector connects the base unit to various pieces of clothing or clothing accessories or to a watchband.

The power source(s) provides electrical power to the wireless transmitter(s) and receiver unit(s), the speaker(s) and alarm unit(s), the microcontroller, the memory unit(s), and indicator lights. The power source may receive electricity via an external connection or power plug.

The wireless transmitter and receiver unit may be useful for wirelessly communicating a signal to another communication device that is remotely located with respect to the user's location. The remote security provider may be located anywhere there is access to appropriate cell-phone towers and other necessary communication means. The remote security provider may further provide integrated access and quick communications with several different public and private emergency and security personnel providers. The TR unit may receive a response signal from a remote location in order to initiate further functions. The aforementioned functions may include initiating an alert to the user that the appropriate security personnel have received the distress signal. Furthermore, the functions may initiate the alert or another alert indicating that appropriate security personnel are enroute to their location.

The speaker(s) and alarm unit(s) may alert local persons of an emergency by emitting audible sounds. The alert sounds may vary and may be designed to cause a reaction from nearby persons. The memory unit may be useful for storing data files containing information needed for operating the base unit or medical or other information about the user. The emergency signal buttons can be located on a plane above the self-contained enclosure such that visually impaired and non-visually impaired users alike can manipulate the emergency signal buttons effectively and accurately. In some embodiments, the microcontroller is configured to have a conspicuous mode and an inconspicuous mode. In the inconspicuous mode, the system completely or largely curtails auditory or visual output. Thus, an assailant may remain ignorant of the true function of the system. In some embodiments, a vibrating device is connected to the microcontroller and the microcontroller uses the vibrating device to communicate with the user when the microcontroller is in inconspicuous mode.

A second embodiment comprising a pendant and a third embodiment comprising a watch are also envisioned herein. Future models may also comprise a fitness training device capable of tracking a user's motion.

The present invention holds significant improvements and serves as a handheld emergency communications and location information system. For purposes of summarizing the invention, certain aspects, advantages, and novel features of the invention have been described herein. It is to be understood that not necessarily all such advantages may be achieved in accordance with any one embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, handheld emergency communications and location information system, constructed and operative according to the teachings of the present invention.

FIG. 1A shows a perspective view illustrating a handheld emergency communications and location information system during an ‘in-use’ condition showing a user signaling an emergency according to an embodiment of the present invention.

FIG. 1B shows a perspective view illustrating the handheld emergency communications and location information system during an ‘in-use’ condition showing a remote emergency response personnel receiving and responding to a transmitted emergency signal according to an embodiment of the present invention.

FIG. 2 is a front perspective view illustrating the handheld emergency communications and location information system according to an embodiment of the present invention.

FIG. 3 is a rear perspective view illustrating a self-contained enclosure of the handheld emergency communications and location information system according to an embodiment of the present invention.

FIG. 4 is a perspective view illustrating components located within an inner volume of the self-contained enclosure of the handheld emergency communications and location information system according to an embodiment of the present invention.

FIG. 5A is a perspective view illustrating the handheld emergency communications and location information system according to an alternate embodiment of the present invention.

FIG. 5B is a perspective view illustrating the handheld emergency communications and location information system according to another alternate embodiment of the present invention.

FIG. 6 is a flowchart illustrating the steps performed by the first-button of the emergency signal buttons of the handheld emergency communications and location information system according to an embodiment of the present invention.

FIG. 7 is a flowchart illustrating the steps performed by a second-button of the emergency signal buttons of the handheld emergency communications and location information system according to an embodiment of the present invention.

FIG. 8 is a flowchart illustrating the steps performed by a third-button of the emergency signal buttons of the handheld emergency communications and location information system according to an embodiment of the present invention.

FIG. 9 is a flowchart illustrating a method of use for the handheld emergency communications and location information system according to an embodiment of the present invention.

FIG. 10 is a perspective view illustrating the handheld emergency communications and location information system having a single button and a display screen according to an alternative embodiment of the present invention.

FIG. 11 is an exploded view illustrating the handheld emergency communications and location information system according to the alternative embodiment of the present invention of FIG. 10.

FIG. 12 is a perspective view illustrating a back plate of a self-contained enclosure of the handheld emergency communications and location information system comprising the physiological sensors according to an alternative embodiment of the present invention of FIGS. 10 and 11.

FIG. 13A is a perspective view of an attachment adapter of the handheld emergency communications and location information system comprising an accessory bar according to an embodiment of the present invention.

FIG. 13B is a perspective view of the attachment adapter of the handheld emergency communications and location information system comprising a magnetic band according to an embodiment of the present invention.

FIG. 14 is a flowchart showing a method of secretly signaling for help when a user is in distress using the handheld emergency communications and location information system according to an embodiment of the present invention of FIGS. 10-12.

The various embodiments of the present invention will hereinafter be described in conjunction with the appended drawings, wherein like designations denote like elements.

### DETAILED DESCRIPTION

As discussed above, embodiments of the present invention relate to a handheld emergency communications and location information system and more particularly to a safe and reliable means for communicating an emergency condition as used to improve personal security and emergency response times for a user, with extended protection against a multitude of potential emergencies in a multitude of different locations.

Generally speaking, as discussed above, embodiments of the present invention relate to a security device and more particularly to a handheld emergency communications and location information system. The handheld emergency communications and location information system may be designed to provide potential victims with a way to communicate with others when they are threatened or in need of assistance.

The present invention may be designed to be used easily and safely by a multitude of users, such as vulnerable children, seniors, women, and many other such persons. The use of the present invention is designed to be user-friendly such that a large percentage of the population could feasibly use the device without needing directions. The emergency signal buttons may provide easy use by visually impaired users as well. For instance, in some embodiments, the emergency signal button or buttons are raised above the surrounding case.

The present invention may be of a compact design to provide a functional attachment to a keychain or as a device capable of being clipped to a belt, pocket, or another article of clothing or a device that may convert to a wearable device, pendant, or watch. To provide easy user accessibility, the present invention may comprise hand-activated buttons.

A first-colored button of the emergency signal buttons may be provided and labeled with a large “911” and may be pushed for general emergencies. An alarm may be provided, so others nearby are made aware of the emergent situation and come to the user's aid. When the present invention is turned on, a GPS tracking system is activated automatically through a wireless transmitter-and-receiver unit or by the microcontroller, so the victim can be located quickly or followed if he or she is abducted or lost. The present invention may also function as a mobile phone capable of two-way communications between the victim and emergency personnel through a built-in microphone and speaker.

The device may comprise a second-colored button (of the emergency signal buttons). In some embodiments, this button may comprise a cross or a red cross. When activated the second-colored button may notify a remote emergency provider of the user's medical emergency. When the button is depressed, it may work in the same manner as the 911 button. An audible alarm may be sounded as well as activation of the GPS and enablement of the two-way communications. The second can function to also transmit pertinent information, such as medical or health information, to a 911 operator or medical responder in an emergency. Medical emergency information may be communicated by the present invention such that an ambulance or other medical emergency providers may be informed with very limited time delay.

The present invention may comprise a third-colored button (of the emergency signal buttons) the functions as a panic button. A user may activate the third-colored button in cases such as an ambush or forced emergencies. When the third-colored button is activated, the device can operate without audible or visual signals. For instance, the device could communicate with the user by vibrating. The vibrations or lights could communicate a variety of messages including how long until help arrives.

Furthermore, activating the button may activate the GPS tracking system, and a silent signal or communication may also be sent. The silent signal may be relayed to a responder, such as the police or a remote security provider. Using the device without an audible signal may communicate a need for immediate assistance without an attacker knowing that the authorities have been notified.

Two indicator lights may be provided. In some embodiments, these lights may be located near the top of the device. The first indicator light may indicate to the user that a signal has been sent from the device. The second indicator light may indicate that the appropriate emergency authorities have been dispatched to the user. This may reassure a user under distress or otherwise in fear for their well-being, that may play an important role in reducing stress and helping the user to remain calm. This reassurance may be particularly beneficial to those persons more prone to reacting poorly to stressful situations, such as the elderly, and relatively more vulnerable persons.

The present invention may also provide a non-emergency control button, in some cases embodied as a small reset/test button on the front side of the base unit. A unique serial number may be provided with the present invention, that may specifically reference a user's confidential profile and account information. Vital information about the owner may be available to emergency personnel. Remote emergency personal could update this information, such as by using a website, directly or through an app, where a user or other authorized persons may input a user's current medical, physical, and other pertinent information. The vital information may include a photo, a generalized description, and age, a height, a weight, and emergency contacts of the user.

When the general and medical emergency buttons are applied, 911 services may have access to the vital information of the user. Alternate models of the present invention may be worn as a watch, a necklace, or a bracelet. These may include a camera, that may be activated to capture visual information, such as a picture of a perpetrator for relay to the proper authorities, such as local police. In some embodiments, the system communicates with home protection systems. For instance, the system could be arranged or programmed to arm and disarm a home security system without needing access to the interior keypad, thus providing security controls while away from home. In some embodiments, the system comprises a fitness training device capable of tracking a user's motion for the system can contain the functionality of fitness trackers and fitness training devices.

The unique features of the present invention may provide the following benefits for all users: a personal security device that will notify police and medical emergency personnel when assistance is needed; a medical alert system that may provide emergency safety coverage when away from home; a simple to operate device useful for children, adults, and seniors; a compatible device for visually impaired users which could use buttons or braille so that visually impaired users may differentiate the appropriate buttons; access to an emergency service provider, such as 911 personnel for those users without access to a mobile phone; a water resistant device; a device upon application of an emergency button that may continually relay a signal to remote emergency personnel until a response signal is provided; an indicator light providing the user with real time confirmation of the status of the emergency; a device with an emergency button that may activate an audible alarm sound; a device with an attachment means such as a belt clip or a quick release key chain; a means to track a user's location through GPS to provide assistance to users during ongoing crimes, and a device to provide piece of mind for users on the go. In some embodiments, the device can communicate with the user's home protection system or alarm system. In these or other embodiments, the device can serve as a fitness device that also contains the panic or emergency functionality described above.

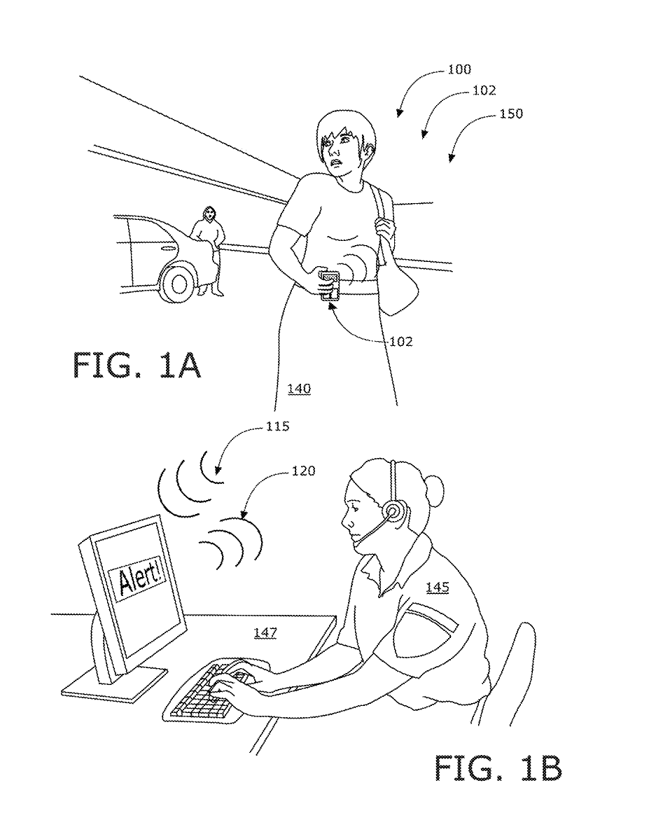

Referring now to drawings by numerals of reference there may be shown in FIGS. 1A-9, various views of an embodiment of a handheld emergency communications and location information system 100. Various embodiments of the system comprise one or more of base unit 102, wireless transmitter-and-receiver unit 436, speaker-and-alarm unit, microcontroller 440, memory unit 442, power source 444, emergency signal buttons 202, non-emergency control buttons 204, first indicator light 208, second indicator light 210, and object-connector 215. Base unit 102 may comprise self-contained enclosure 220. Self-contained enclosure 220 may include front plate 222, rear plate 324, and inner volume 426.

FIGS. 1A-1B, FIG. 1A show system 100 during an ‘in-use’ condition 150. A user in a potentially life-threatening situation may send communication signal 115 through base unit 102. FIG. 1B shows remote emergency personnel 145 who may receive communication signal 115 and respond through response signal 120 to an emergency.

As further shown in FIGS. 1A-1B, base unit 102 may be carried on a belt of the user. This may provide a means for the user to inconspicuously activate base unit 102 if in a threatening or otherwise distressful situation. As shown, the user may activate base unit 102 and communication signal 115 may then be sent to remote emergency provider 147. Remote emergency provider 147 may be a 911 responder or a member of a private or public security service provider.

Remote emergency provider 147 may be in direct communication with the emergency and rescue service providers including but not limited to, police, fire department, emergency medical services (EMS), emergency telephone numbers (i.e., 911), search and rescue, mountain rescue, and coastguard. The list above of service providers may allow for the most appropriate and fastest response time for a user's emergency. Remote emergency provider 147 may further provide vital information such as current medical information, physical needs, photo, generalized description, age, height, weight, and emergency contacts of the user to the emergency and rescue service providers. In some embodiments, this information is transmitted from system 100 to remote emergency provider 147 automatically.

In various embodiments, the system 100 only has an inconspicuous mode. In these embodiments, a single button device, when activated, alerts 911 or emergency responders through the cellular network. In some of these embodiments, GPS is turned on at the same time as the system is activated. In some of these embodiments, inconspicuous mode functions as described below. Similar embodiments may contain a single panic button attached to system 100 or a fitness tracker. When the panic button is activated, the signal goes directly to 911 or the emergency responder. The device can receive and alert the user via vibration or using changing indicators on the digital display.

In some embodiments, system 100 communicates directly through the cellular network or another wide area network, and in other embodiments system, 100 communicates through an app on a smartphone or another external device, by connecting to a wide area network through an external device, through blue tooth, or through the user's cell phone.

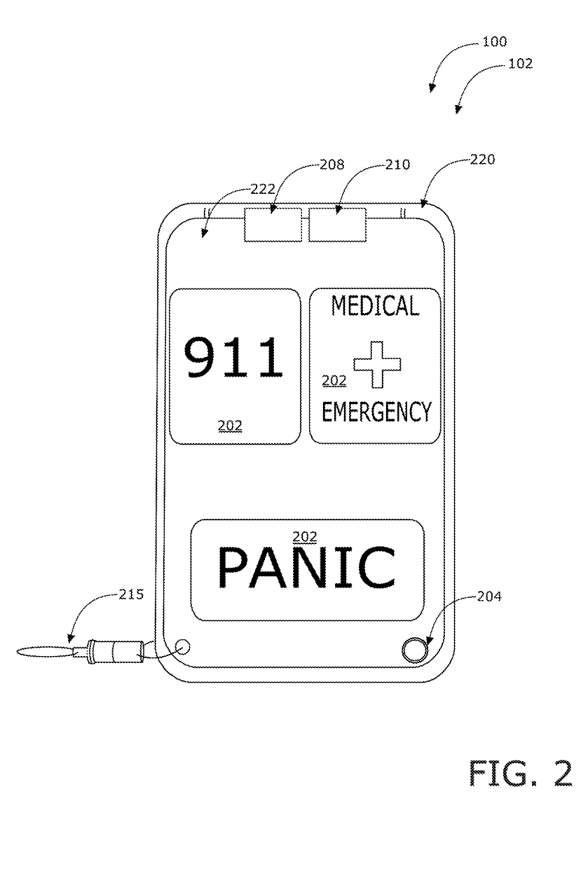

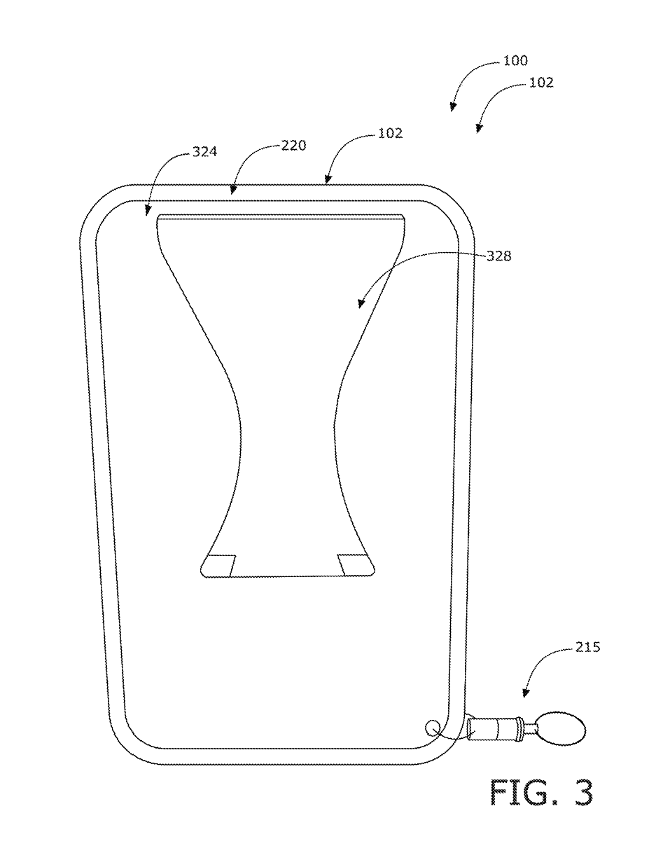

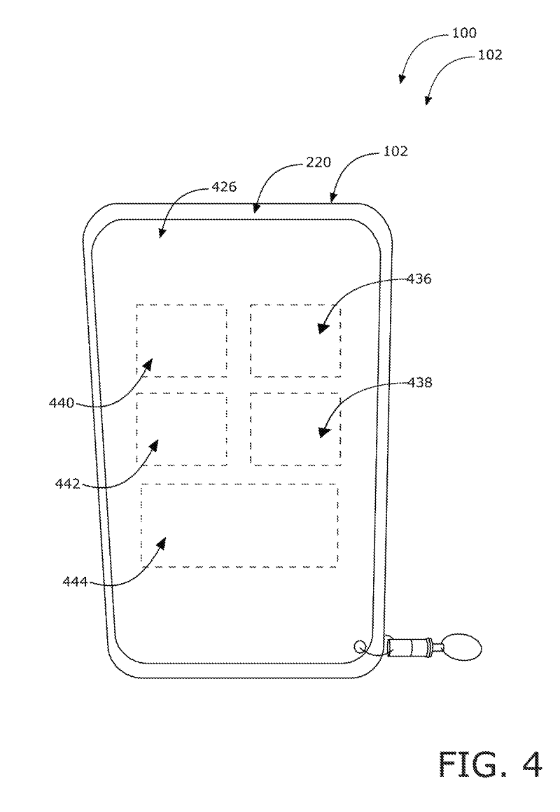

FIG. 2 shows a front view illustrating system 100. System 100 may comprise base unit 102. Self-contained enclosure 220 may embody features of base unit 102. Front plate 222 may embody a section of a protective casing of self-contained enclosure 220. Front plate 222, rear plate 324 (as shown in FIG. 3), and inner volume 426 (as shown in FIG. 4) may structurally define parameters of self-contained enclosure 220. Front plate 222 and rear plate 324 (as shown in FIG. 3) of self-contained enclosure 220 may seal off inner volume 426 (as shown in FIG. 4) to provide an effectively water-resistant assembly.

As shown in FIG. 2, the emergency signal buttons 202 may be located on a front side of base unit 102. The emergency signal buttons 202 may embody three separate buttons that may be hand-activated. As shown in this embodiment, a first button of the emergency signal buttons 202 may be labeled ‘911’ and may further comprise braille indicating 911 general emergency for visually impaired users. Communication signal 115 pertinent to vital information of the user may be communicated once upon activation of various emergency signal buttons 202. Alternatively, communication signal 115 may be repeatedly relayed until wireless receiver unit 436 receives response signal 120 (as shown in FIG. 4). Mobile phone communication signal 115 may be repeatedly communicated upon activation of one or more emergency signal buttons 202. A GPS location information communication signal 115 may be repeatedly communicated upon activation of one or more emergency signal buttons 202.

FIG. 2 also shows the second button of the emergency signal buttons 202 may be labeled ‘medical emergency’ and further labeled with a cross similar to that of a first aid cross symbol. Those of ordinary skill in the art will recognize that the buttons need not be labeled in this way depending upon the various embodiments of the invention. The second button of the emergency signal buttons 202 may further comprise braille indicating a medical emergency for the visually impaired. As shown, the third button of the emergency signal buttons 202 may be labeled ‘panic’ and may further comprise braille indicating panic for the visually impaired. The emergency signal buttons 202 may be located on a plane above front plate 222 of self-contained enclosure 220 such that a visually impaired user and a non-visually impaired user may manipulate emergency signal buttons 202 effectively and accurately.

As further shown in FIG. 2, non-emergency control button 204 may be located on front side of base unit 102 and may embody reset/test button. A first indicator light 208 may be located on the front side of base unit 102 and may communicate to the user with a blinking, intermittent, or a solid light. A second indicator light 210 located on the front side of base unit 102 may communicate to the user with a blinking, intermittent, or a solid light. The emergency signal buttons 202, the non-emergency control buttons 204, first indicator light 208, and second indicator light 210 may be fixedly mounted to base unit 102, contiguous to front plate 222 of self-contained enclosure 220.

FIG. 2 also shows object-connector 215 fixedly located on a front side of base unit 102. Object-connector 215 may embody a quick release key chain clip useful for attaching the device to a key ring. The quick release key chain clip may securely connect to base unit 102 through a key ring penetrating perforation hole in base unit 102, as shown.

FIG. 3 shows a rear view of the system 100. System 100 may comprise base unit 102. Rear plate 324 may embody a rear section of the protective casing of self-contained enclosure 220. Object-connector 215 may be accessible from the rear of base unit 102, as shown. Object-connector may comprise belt clip 328 located on the rear of base unit 102, useful for attaching to the belt of the user for ease of portability. Belt clip 328 may be manufactured of flexible material such that the user may flex material by hand to attach belt clip 328 to the belt of a user, or elsewhere on the user.

FIG. 4 shows a perspective view illustrating system 100 that may comprise inner volume 426 of self-contained enclosure 220. As shown, wireless transmitter-and-receiver unit 436, speaker-and-alarm unit 438, microcontroller 440, memory unit 442, and power source 444 may securely mount within the inner volume of self-contained enclosure 220. Self-contained enclosure 220, wireless transmitter-and-receiver unit 436, speaker-and-alarm unit 438, microcontroller 440, memory unit 442, power source 444, emergency signal buttons 202 (as shown in FIG. 2), non-emergency control buttons 204 (as shown in FIG. 2), first indicator light 208 (as shown in FIG. 2), second indicator light 210 (as shown in FIG. 2), and object-connector 215 (as shown in FIG. 2) may comprise in structural combination base unit 102. The listed components may be arranged and interconnected in a multitude of varying manners to provide functional capabilities desired by the user. Furthermore, other unnamed optional components may be provided within inner volume 426 of self-contained enclosure 220.

Wireless transmitter-and-receiver unit 436 may be useful for wirelessly communicating communication signal 115 to communication device 147 that may be remotely located with respect to wireless transmitter-and-receiver unit 436. Wireless transmitter-and-receiver unit 436 may function as a component of the GPS location system, as well as a component of the mobile phone system of the present invention. Speaker-and-alarm unit 438 may be useful for emitting an audible sound. The audible sound may be initiated when an emergency signal button 202 is activated.

Memory unit 442 may be useful for storing data files and may comprise parameters for operating base unit 102. Memory unit 442 may comprise an SD-card that may store information. Memory unit 442 may further comprise a SIM-card intended to securely store a related key that may be used to identify and authenticate the user of the present invention. memory unit 442 may further store vital information such as personal data pertinent to the user.

Microcontroller 440 may communicate with wireless transmitter-and-receiver unit 436, speaker-and-alarm unit 438, memory unit 442, the emergency signal buttons 202 (as shown in FIG. 2), the non-emergency control buttons 204 (as shown in FIG. 2), first indicator light 208 (as shown in FIG. 2), and second indicator light 210 (as shown in FIG. 2). Microcontroller 440 may further comprise a processor core, memory, and programmable input/output peripherals to control the functional components of base unit 102.

Power source 444 may provide electrical operating power to wireless transmitter-and-receiver unit 436, speaker-and-alarm unit 438, microcontroller 440, memory unit 442, first indicator light 208 (as shown in FIG. 2), and second indicator light 210 (as shown in FIG. 2). Power source 444 may further be rechargeable and receive electricity through an external connection/power plug or other suitable means.

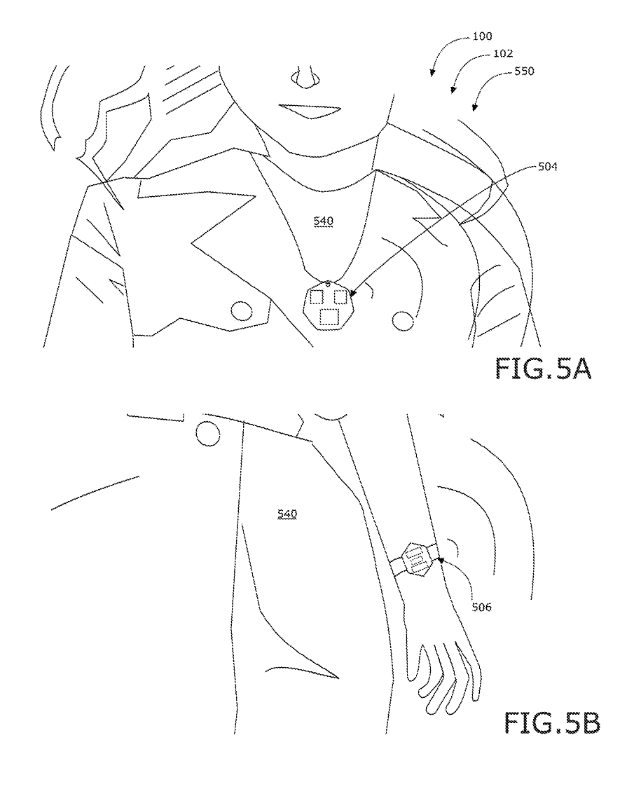

Referring now to FIGS. 5A and 5B, illustrating system 100 showing alternate embodiments as pendant 504 and watch 506 of base unit 102 during ‘in-use’ condition 550. As shown in FIG. 5A, users may wear alternate embodiment 504 around their neck. The alternate embodiment 504 may comprise similar components and functionality to that of the preferred embodiment of invention. As shown in FIG. 5A, users may wear alternate embodiment 506 around their wrist. The alternate embodiment 506 may comprise similar components and functionality to that of the preferred embodiment of the invention.

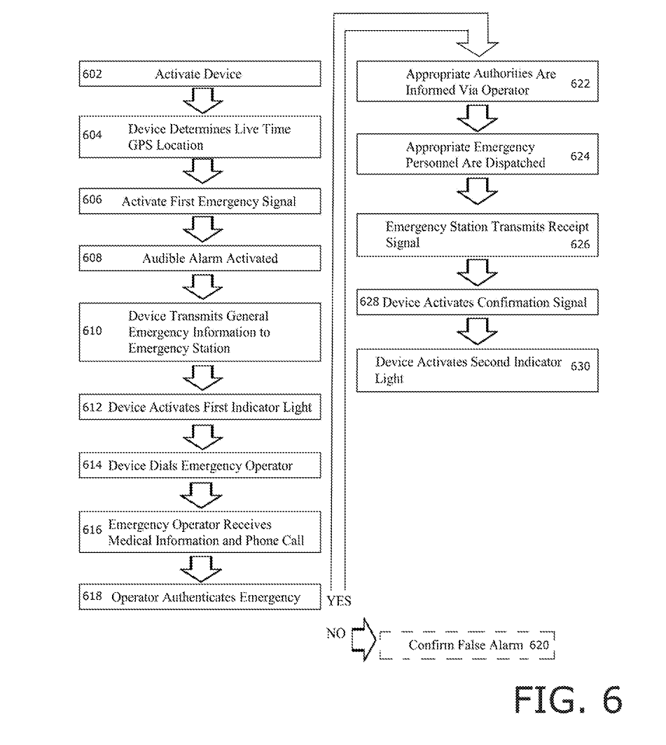

FIG. 6 shows a flowchart 600 illustrating steps performed by a button of the emergency signal buttons of system 100. As shown, the button may initiate steps that comprise step 602 activating the device, step 604 activating the device to determining live time GPS location, step 606 activating first emergency signal, step 608 activating audible alarm, step 610 transmitting general emergency information to emergency station, step 612 illuminating the first indicator light, step 614 dialing emergency operator, step 616 receiving signal to authenticate from operator, step 618 testing for false alarm condition, step 620 sending authentication information to operator, step 624, receiving receipt signal from emergency station, step 628 activating confirmation signal, step 630 activating second indicator light. It should be noted that step 620 may be optional step and may not be implemented in all cases. Optional steps performed by first button of the emergency signal buttons 600 may be illustrated using dotted lines in FIG. 6 so as to distinguish them from other steps of method of use 600.

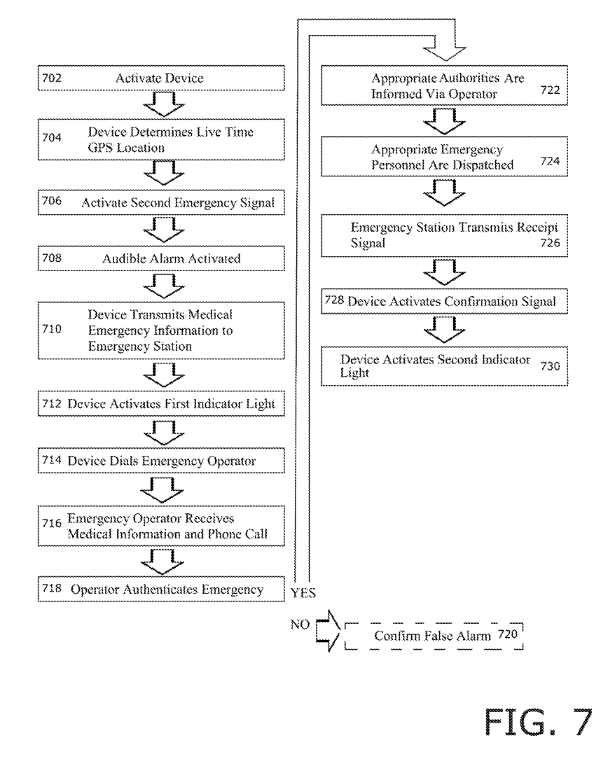

FIG. 7 shows a flowchart illustrating steps performed by another of the emergency signal buttons 700 of system 100. As shown, these steps may comprise step 702 activating device, step 704 determining live time GPS location, step 706 activating second emergency signal, step 708 activating audible alarm, step 710 transmitting medical emergency information to emergency station, step 712 activating first indicator light 712, step 714 dialing emergency operator, emergency operator receives medical information and phone call 716, step 718 receiving authentication query from operator, step 720 answering authentication query, step 726 receiving receipt signal, step 728 activating confirmation signal, step 730 activating 2^{nd} indicator light. It should be noted that step 720 may be optional step and may not be implemented in all cases. Optional steps performed by this button of the emergency signal buttons 700, may be illustrated using dotted lines in FIG. 7 so as to distinguish them from other steps of method of use 700.

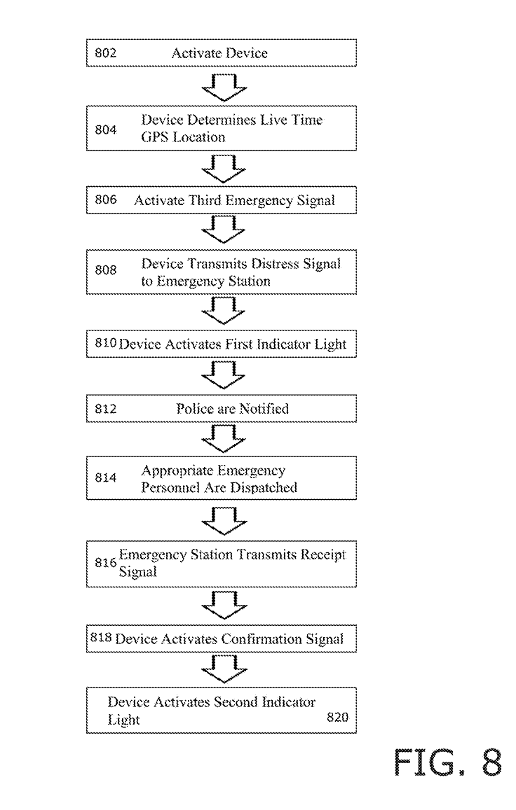

FIG. 8 shows a flowchart illustrating steps performed by yet another button of the emergency signal buttons 800 of system 100. The steps comprise step 802 activating device 802, step 804 determining live time GPS location 804, step 806 activating first emergency signal, step 808 transmitting distress signal to emergency station 808, step 810 activating first indicator light 810, step 816 receiving receipt signal 816, step 818 activating confirmation signal 818, and step 820 activating second indicator light 820.

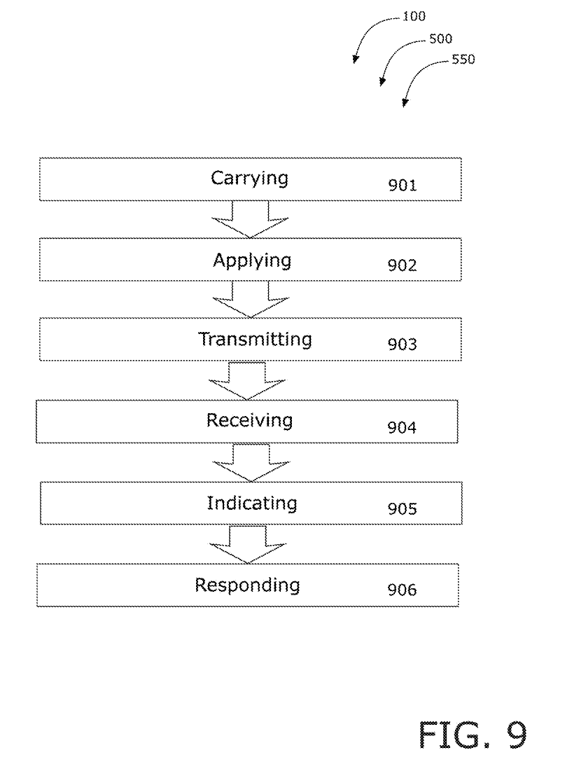

FIG. 9 flowchart 950 illustrating a method of use 900 for system 100 according to an embodiment of the present invention of FIGS. 1A-9. Method of use 900 comprises: step 901, carrying, step 902, applying, step 903, transmitting, step 904, receiving, step 905, indicating, and step 906, responding.

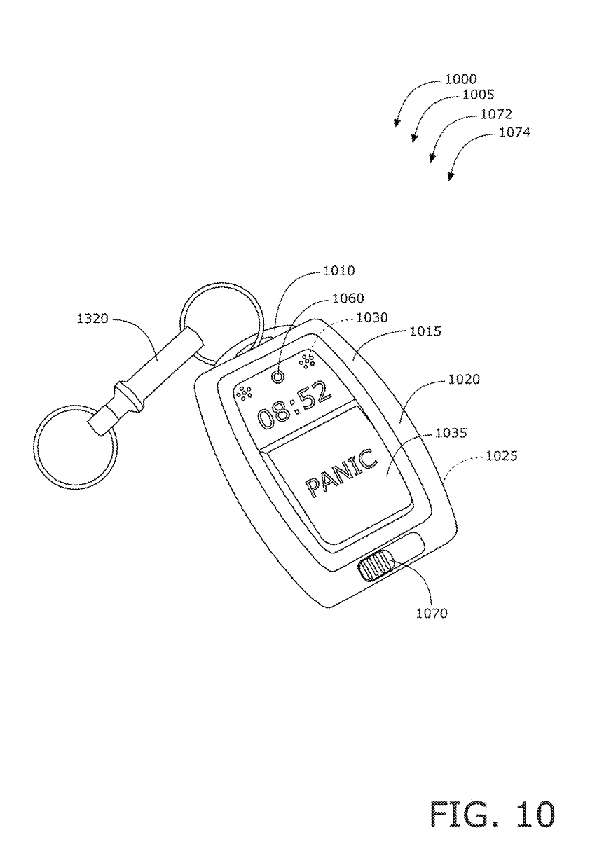

FIG. 10 shows another embodiment of handheld emergency communications and location information system 1000 according to the present disclosure. As shown, system 1000 may comprise base unit 1005, which may include self-contained enclosure 1015 having front plate 1020 and rear plate 1025 coupled together and defining inner volume 1030; at least one wireless transmitter-and-receiver unit 1110; at least one speaker-and-alarm unit 1120; digital display screen 1130 mounted to front plate 1020; microcontroller 1140; at least one memory unit 1150; at least one power source 1160; and at least one emergency signal button 1035 mounted to front plate 1020. Further, system 1000 may also comprise attachment adapter 1010 configured to attach base unit 1005 to a wearable (and alternatively a non-wearable) article.

FIG. 10, also shows that self-contained enclosure 1015 may comprise at least one wireless transmitter-and-receiver unit 1110, at least one speaker-and-alarm unit 1120, digital display screen 1130, microcontroller 1140, at least one memory unit 1150, at least one power source 1160, and at least one emergency signal button 1035 in structural combination. Further, at least one wireless transmitter-and-receiver unit 1110, at least one speaker-and-alarm unit 1120, digital display screen 1130, microcontroller 1140, at least one memory unit 1150, and at least one power source 1160 are securely mounted within the inner volume of self-contained enclosure 1015.

FIG. 10 shows digital display screen 1130 mounted to front plate 1020 of self-contained enclosure 1015 and is configured to display data and information. In one embodiment, digital display screen 1130 may display time (as kept by clock 1180), messages from third party personnel, vital sign information (as detected by at least one physiological sensor 1210), and other information.

FIG. 10 shows base unit 1005 comprising a switch 1070. Switch 1070 may be configured to toggle between an inconspicuous mode and a conspicuous mode. In other embodiments, switch 1070 may comprise a button.

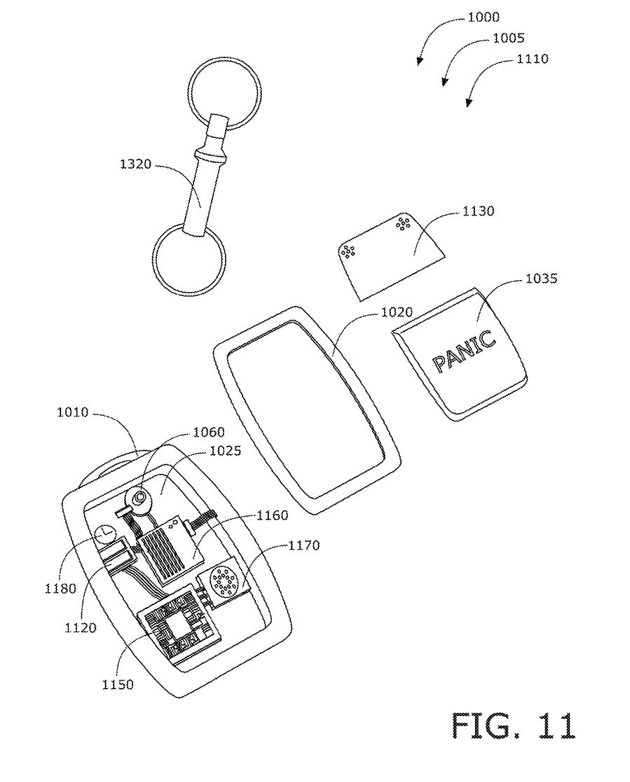

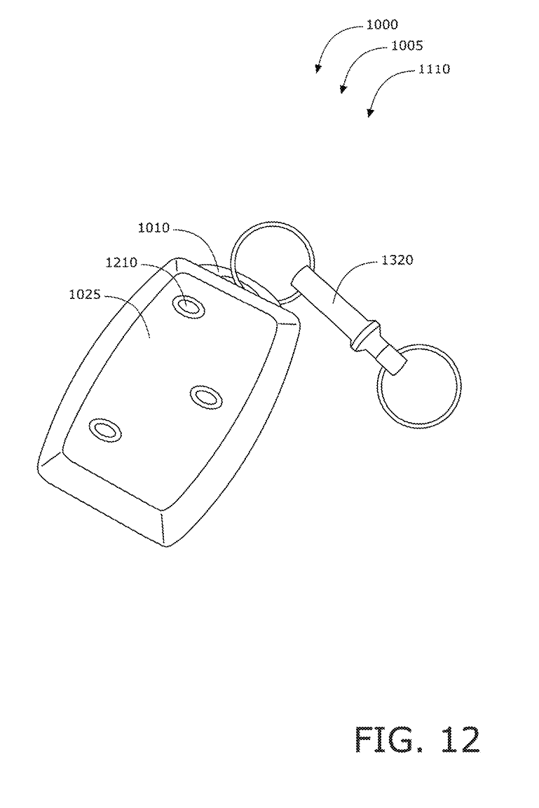

FIG. 11 shows an exploded view of handheld emergency communications and location information system 1000 according to an embodiment of the present invention. As shown, microcontroller 1140 communicates with a wireless transmitter-and-receiver unit 1110, a speaker-and-alarm unit 1120, digital display screen 1130, a memory unit 1150, a power source 1160, and an emergency signal button 1035. The power source 1160 serves to provide operating power to base unit 1005. In one embodiment, the power source 1160 may comprise a battery. Other power sources 1160 may include, but are not limited to, a single battery, a rechargeable battery, photovoltaic cells, and the like.

FIG. 11 shows that a wireless transmitter-and-receiver unit 1110 may be configured to transmit a wireless signal when an emergency signal button 1035 is pressed. Preferably, the wireless signal is transmitted to another communication device which is remotely located with respect to a wireless transmitter-and-receiver unit 1110. It should be noted that another communication device may comprise a Smartphone, a tablet, a computer, or any communication device configured to receive a wireless signal. Further, it should be noted that the wireless signal transmitted by a wireless transmitter-and-receiver unit 1110 may be encoded. In such a manner, base unit 1005 the user may be uniquely coded to the user. In addition, the wireless signal may be free of interference during transmission.

FIG. 11 shows an embodiment in which speaker-and-alarm unit 1120 may be configured to emit an audible sound. For example, a speaker-and-alarm unit 1120 may emit a sound when an emergency signal button 1035 is pressed. In another example, a speaker-and-alarm unit 1120 may emit a sound when a return signal is received by a wireless transmitter-and-receiver unit 1110. In yet another example, speaker-and-alarm unit 1120 may emit a sound when system 1000 is powered on or off, or when system 1000 is low on power. Further, speaker-and-alarm unit 1120 may be configured to emit a loud alarm sound when emergency signal button 1035 is pressed, held, or pressed and held. In some embodiments, the audible sound can be voice communication including two-way voice communication. Additionally, system 1000 can be set up to use vibrating mechanism 1170 as a signal both when the system is in inconspicuous mode and when the system is not in inconspicuous mode.

FIG. 11 shows memory unit 1050 useful for storing a data file comprising parameters for operating base unit 1005. Additionally, memory unit 1050 can contain other data such as personal profile, medical information, medical history, and so forth. Microcontroller 1140 may function in combination with wireless transmitter-and-receiver unit 1110 to receive and track coordinates of the relative location of base unit 1005. Further, microcontroller 1140 may be configured to transmit the coordinates to another communication device controlled by ⅓ party through wireless transmitter-and-receiver unit 1110 when emergency signal button 1035 is pressed. Thus, system 1000 is configured and useful for allowing the user to transmit a real-time emergency signal to a third party who can expediently respond to the user's emergency.

In the embodiment shown in FIG. 11, base unit 1005 may comprise vibrating mechanism 1170 fixedly mounted within inner volume 1030.

Referring to FIGS. 10 and 11, inconspicuous mode 1072, when activated by switch 1070, is configured to activate vibrating mechanism 1170 and to deactivate speaker unit 1120 and, in some embodiments, digital display screen 1130. In that mode base unit 1005 will not emit any sounds or lights to give any aural or visual indication to an assailant when the user is under duress. Further, while in inconspicuous mode 1072, vibrating mechanism 1170 may be configured to pulsate a first time when the real-time emergency signal is successfully transmitted by wireless transmitter-and-receiver unit 1110 and a second time when real-time emergency signal is successfully received by another communication device. This may indicate to the user a successful transmission of the real-time emergency signal discretely and without detection by an assailant. Yet still, vibrating mechanism 1170 may be configured to pulsate when a second return signal is received by wireless transmitter-and-receiver unit 1110. This may indicate to the user discretely and without detection by an assailant that a third party has received the real-time emergency signal. When in inconspicuous mode, the microcontroller can keep the camera active but deactivate the flash. Instead of or in addition to the vibrating mechanism, in inconspicuous mode, the microcontroller can signal the user by putting data, such as a colored light or dot, on the display. In some of these embodiments, the microcontroller could keep the display dark after putting data on the display and only illuminate the display where the user activated the display. In some embodiments, the microcontroller turns off the display a set amount of time after the user activates the display so that inconspicuous mode is not compromised.

Referring to FIGS. 10 and 11, conspicuous mode, when activated by switch 1070 or a button, activates features such as digital display screen 1130, speaker-and-alarm unit 1120, and camera 1060. When in conspicuous mode, digital display screen 1130 may be configured to display a color. A color comprises a first color useful for indicating a successful transmission of the real-time emergency signal to another communication device. Further, a color comprises a second color useful for indicating when the wireless transmitter-and-receiver unit receives a return signal from another communication device. In addition, digital display screen 1130 may be configured to display a message related to a status of emergency assistance. A third-party may initiate a response to the user (for example, a text message sound, a vibration or pulsation, or other visual indication on digital display screen 1130). Incoming transmissions may trigger any or all the above user indicators to show the user how many minutes until help arrives. For example, the number of stimuli received could correspond to the number of minutes (i.e. five minutes would be five vibrations).

Further, digital display screen 1130 may be configured to display a time as kept by clock 1180. Clock 1180 may be securely mounted within self-contained enclosure 1015. The time as kept by clock 1180 may be configured to alternate or change colors to provide subtle visual indication to a user that assistance is on the way. Yet still, digital display screen 1130 may be configured to show a numeric countdown in big numbers when help is on the way. As improvements in GPS locator technology develops, it should be appreciated that the digital display time for ETA of help may become roughly calculable by the second to provide the user with a close-to-real-time, help-arrival clock.

In continuing to refer to FIGS. 10 and 11, and one embodiment of the present invention base unit 1005 may comprise camera 1060. Camera 1060 may be configured to capture a digital image, such as a picture or video, when an emergency signal button 1035 is pressed. Further, the digital image may be wirelessly transmitted to another communication device when an emergency signal button 1035 is pressed. In such a manner, the user may be able to capture a digital image of an assailant when in distress and communicate the digital image immediately to the third party. This may serve to prevent or deter an attack when the assailant is aware that his or her likeness has been captured and sent to emergency personnel. Further, base unit 1005 may comprise a flash to use camera 1060 in low ambient environments (such as in a parking garage or at night).

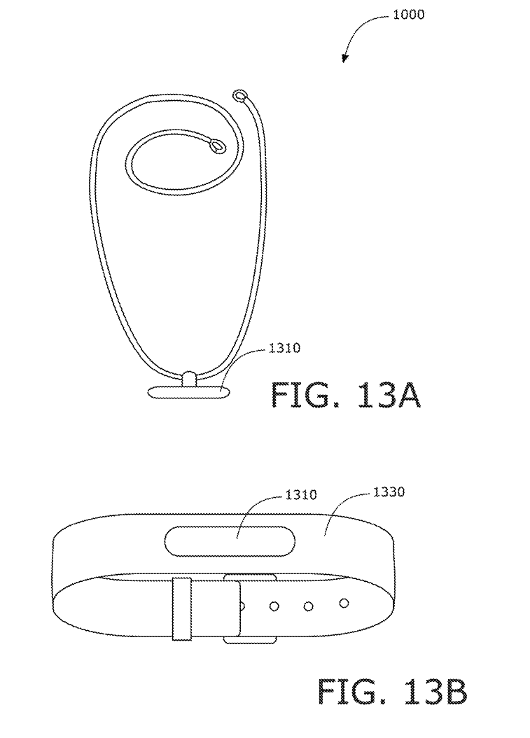

FIG. 13A shows an accessory or attachment adapter 1010 of handheld emergency communications and location information systems 1000 according to an embodiment of the present invention. As shown, attachment adapter 1010 may comprise accessory bar 1310 and alternatively quick release fastener clip 1320. Accessory bar 1310 and quick release fastener clip 1320 may be configured to attach to a necklace, a cord, a watch band, a belt clip, or the like, as shown.

FIG. 13B shows attachment adapter 1010 according to an embodiment of the present invention. As shown, attachment adapter 1010 may comprise magnetic band 1330, which may be configured to magnetically couple base unit 1005 to a wearable article or non-wearable article.

In one embodiment of the present disclosure, system 1000 may comprise self-contained enclosure 1015 having front plate 1020 and rear plate 1025 coupled together and defining inner volume 1030; wireless transmitter-and-receiver unit 1110; speaker-and-alarm unit 1120; digital display screen 1130 mounted to front plate 1020; microcontroller 1140; memory unit 1150; power source 1160; vibrating mechanism 1170; clock 1180; camera 1060; switch 1070 for toggling between inconspicuous mode and conspicuous mode; and emergency signal button 1035 mounted to front plate 1020. System 1000 may also comprise attachment adapter 1010 configured to removably attach base unit 1005 to a wearable (and alternatively a non-wearable) article.

Further, system 1000 may comprise a physiological sensor 1210 mounted to rear plate 1025 of self-contained enclosure 1015. A physiological sensor 1210 may be configured to detect a physiological parameter of the user when a physiological sensor 1210 contacts the user's skin surface. Sensor 1210 may be configured to detect parameters of the user such as heart rate, body temperature, pulse, respiratory rate, and the like. Further, microcontroller 1140 may be configured to activate wireless transmitter-and-receiver unit 1110 to transmit emergency signals to third party when a physiological sensor detects an escalated heart rate or other medical emergency condition of the user.

In yet another embodiment, emergency signal button 1035 may be configured to cause wireless transmitter-and-receiver unit 1110 to transmit encoded messages or signals to a third-party (for example, emergency personnel, private security dispatch companies, national 911 services, family members, or emergency contacts) using a sequence of pressing or tapping on emergency signal button 1035 to signal specific emergencies. All embodiments can employ encoded messages or signals.

### Example

the user presses once. This sends an encoded messages signaling an accident or requesting police. The user presses twice. This sends an encoded message signaling a medical emergency. The user presses three times. This causes wireless transmitter-and-receiver unit 1110 to transmit an encoded signal that the user is under immediate duress, for example, an ambush or assault emergency, and that the user can safely communicate verbally.

In some embodiments of the present invention, each base unit 1005 may be registered. Registration may include a step of creating a user account for identifying the user. A second step may include adding emergency contact information related to the user. Further, the user account may include a billing profile for billing the user for services.

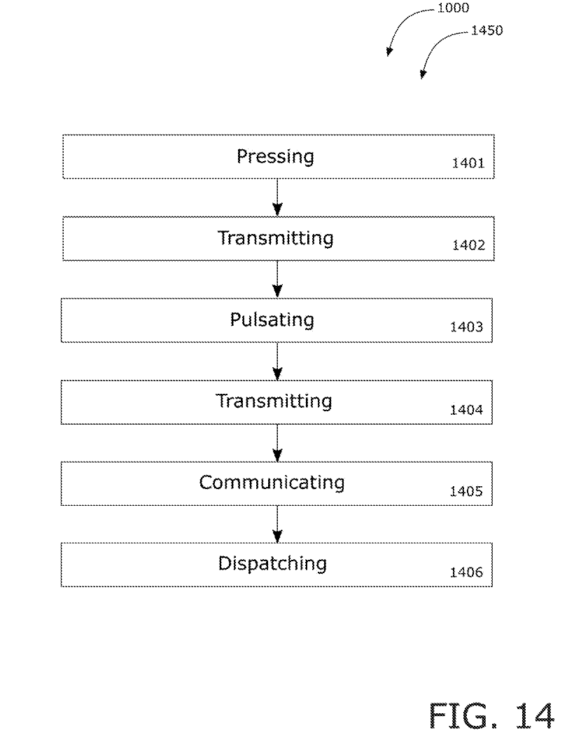

FIG. 14 shows a flowchart 1450 depicting a method of use 1400 of secretly signaling for help when the user is in distress using system 100, 1000. The method comprises step 1401, pressing an emergency signal button 1035 mounted to front plate 1020 of self-contained enclosure 1015; step 1402, transmitting a real-time emergency signal through wireless transmitter-and-receiver unit 1110 to a third party who can respond to an emergency situation of the user; step 1403, pulsing self-contained enclosure 1015 through vibrating mechanism 1170 to inconspicuously indicate to the user successful transmission and receipt of the real-time emergency signal; and step 1404, transmitting a location of the user to a third party.

It should be noted that the steps described in the method of use can be carried out in many different orders according to user preference. The use of “step of” should not be interpreted as “step for”, in the claims herein and is not intended to invoke the provisions of 35 U.S.C. § 112,¶16. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A handheld emergency communications and location information system comprising:
a base unit including:
an enclosure having an inner volume containing:
a wireless transmitter-and-receiver unit (TR unit);
a microcontroller;
a memory unit;
a power source;
and
an emergency signal button,
wherein the emergency signal button is mounted in the enclosure,
wherein the microcontroller is connected to the TR unit, the memory unit, and the emergency signal button,
wherein the microcontroller is configured to activate the TR unit to transmit a wireless signal when the microcontroller receives input from the emergency signal button,
wherein the memory unit contains a data file comprising parameters for operating the base unit,
and
wherein the wireless signal is a real-time emergency signal to a third party capable of expediently responding to the user's emergency.

2. The system of claim 1 wherein the microcontroller controls the TR unit to receive and track an absolute or relative location of the base unit.

3. The system of claim 2 wherein the wireless signal contains data related to the absolute or relative location of the base unit.

4. The system of claim 3 wherein the microcontroller reads input from the emergency signal button and activates the wireless-transmitter-and-receiver unit when the input matches a pre-defined pattern.

5. The system of claim 4 further comprising a digital display screen configured to display data and information and connected to the microcontroller.

6. The system of claim 5 further comprising a speaker-and-alarm unit connected to the microcontroller and configured to emit a sound.

7. The system of claim 6 wherein the base unit further comprises a button or a switch connected to the microcontroller and wherein the microcontroller is configured to toggle between a conspicuous mode and an inconspicuous mode in response to data from the button or switch.

8. The system of claim 7 wherein the base unit further comprises a vibrating mechanism mounted inside the enclosure and connected to the microcontroller.

9. The system of claim 8 wherein the microcontroller is configured to activate the vibrating mechanism and deactivate the speaker-and-alarm unit when the inconspicuous mode is activated.

10. The system of claim 9 wherein the microcontroller is configured to deactivate the digital display screen, when the inconspicuous mode is activated.

11. The system of claim 10 wherein microcontroller causes the vibrating mechanism to vibrate after causing the FT unit to send the emergency signal and detecting a response signal from the third party.

12. The system of claim 7 wherein the digital display screen is configured to display at least a first color and a second color and to flash lights.

13. The system of claim 12 wherein the microcontroller causes the screen to display the first color after causing the FT unit to send the emergency signal.

14. The system of claim 13 wherein the microcontroller causes the screen to display the second color after detecting a response signal from the third party.

14. The system of claim 7 wherein the microcontroller is configured to display on the screen a message related to a status of emergency assistance.

15. The system of claim 12 wherein the message contains a timer indicating an estimated time of arrival of emergency assistance.

16. The system of claim 7 wherein the base unit further comprises a camera.

17. The system of claim 16 further comprising a flash wherein the microcontroller is configured to deactivate the flash when the microcontroller is in inconspicuous mode.

18. The system of claim 7 wherein the microcontroller is configured to display on the screen a message related to a status of emergency assistance when the user activates the screen.

19. The system of claim 1 further comprising an attachment adapter, wherein the attachment adapter comprises an accessory bar or a quick release fastener clip and wherein the accessory bar and the quick release fastener clip are configured to attach to a necklace or a cord.

20. A handheld emergency communications and location information system comprising:
a base unit including:
an enclosure having an inner volume containing:
a microcontroller;
a wireless transmitter-and-receiver unit (TR unit) connected to the microcontroller;
a memory unit connected to the microcontroller;
a power source connected to the microcontroller;
a digital display screen connected to the controller and configured to display data, information, and at least a first color and a second color;
a speaker-and-alarm unit connected to the microcontroller and configured to emit a sound;
a switch connected to the microcontroller;
a vibrating mechanism mounted inside the enclosure connected to the microcontroller;
a camera connected to the microcontroller;
a flash;
and
an emergency signal button connected to the microcontroller,
wherein the emergency signal button is mounted in the enclosure,
wherein the microcontroller is configured to control the TR unit to receive and track location data related to an absolute or relative location of the base unit and is configured to activate the TR unit to transmit a wireless signal containing the location data when the microcontroller receives input from the emergency signal button that matches a pre-defined pattern,
wherein the microcontroller is configured to toggle between a conspicuous mode and an inconspicuous mode in response to data from the button or switch,
wherein the microcontroller is configured to activate the vibrating mechanism and deactivate the speaker-and-alarm unit when the inconspicuous mode is activated,
wherein the microcontroller is configured to cause the vibrating mechanism to vibrate after causing the TR unit to send the emergency signal and after detecting a response signal from the third-party,
wherein the microcontroller is configured to cause the screen to display the first color after causing the TR unit to send the emergency signal and is configured to cause the screen to display the 2^{nd} color after detecting a response signal from the third-party,
wherein the microcontroller is configured to deactivate the flash when the microcontroller is an inconspicuous,
wherein the microcontroller is configured to display on the screen a message related to a status of emergency assistance when the user activates the screen,
wherein the memory unit contains a data file comprising parameters for operating the base unit,
and
wherein the wireless signal is a real-time emergency signal to a third party capable of expediently responding to the user's emergency.
